(19) United States
(12) Patent Application Publication
(10) Pub. No.: US 2007/0151776 A1
(43) Pub. Date: Jul. 5, 2007

(54) Powered trailer dolly

(76) Inventor: Richard L. Hart, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/323,605

(22) Filed: Dec. 29, 2005

(51) Int. Cl. B62M 7/14

(52) U.S. Cl. 180/11

(57) ABSTRACT

A towing dolly is provided for relocating wheeled loads such as boat trailers, camping trailers and airplanes where towing forces required may be substantial. The towing dolly may have a wheel assembly with a drive gear disposed between proximate treads. The towing dolly may have a narrow wheel width providing easy steering and compact size for storage. The towing dolly may have a motor with a gear sprocket. A linked chain may transfer power from the motor to the drive gear located between the double treads. The dolly may have a steering arm extending perpendicular to drive direction allowing the operator to stand away from path of movement of the load while providing adequate leverage to steer the dolly. The dolly may have an alternate configuration with a power source located on the dolly providing operation independent of plugins or extension cords.

### FIELD OF THE INVENTION

This invention relates generally to towing devices, especially to powered towing dollies used to move trailered or wheeled loads short distances while being steered with a handle.

### SUMMARY

Wheeled loads such as mobile homes, camping trailers and trailered boats are designed to be attached to a vehicle and towed from one location to another. They are also designed to be detached from the vehicle allowing the vehicle more ease of movement when towing is not required. Trailered loads typically have a tongue extending forward of the load to attach to the vehicle. The load weight of a trailer should be substantially over the wheels but tongue weight can be considerable, making manual towing difficult. Moving a camping trailer to hook it to the vehicle or to get garage access behind the camping trailer can be very difficult. Pulling the unit by hand to get it moving can be challenging. Once moving, it can be dangerous trying to steer the unit and more dangerous trying to stop it. Trailer movement can be undertaken more safely and less strenuously by using a tow dolly.

Tow dollies come in many configurations and may be powered or unpowered. Unpowered dollies are often configured with two side by side wheels, a handle and a ball that mates to a trailer hitch. Pulling on the dolly handle leverages against the wheels and lifts the trailer tongue putting the tongue weight on the dolly wheels. This dolly configuration provides a handle for ease of maneuvering and the trailer tongue is supported by pushing down on the handle which is much less difficult than lifting. Substantial physical force may still be required to start moving the trailered load.

Powered dollies limit the pulling force required by applying motive power to the wheels. Many configurations of powered dollies are used. Powered dollies often have a heavy frame and three or four wheels to support the added weight of motor, drive train or a power source. Some powered dollies have lifting mechanisms as part of the load support. Some are sized to support the user.

Dollies may be used infrequently and may have to be stored. They may need to be lifted or transported themselves. Powered dollies may be complex and require maintenance. Gas powered units require gas, oil and regular maintenance.

A light, powered dolly for trailers with low complexity and a small footprint for easy storage would be advantageous for those needing to move trailers and wheeled loads.

The device described is a powered dolly including a single wheel assembly with double side by side treads closely spaced and separated by a drive gear. The drive gear is fixed to the wheel assembly. Torque may be applied to the wheel assembly by a linked chain between the drive gear and a geared drive motor. A control handle for steering may extend transversely to the direction of travel.

BRIEF DESCRIPTION OF THE DRAWINGS

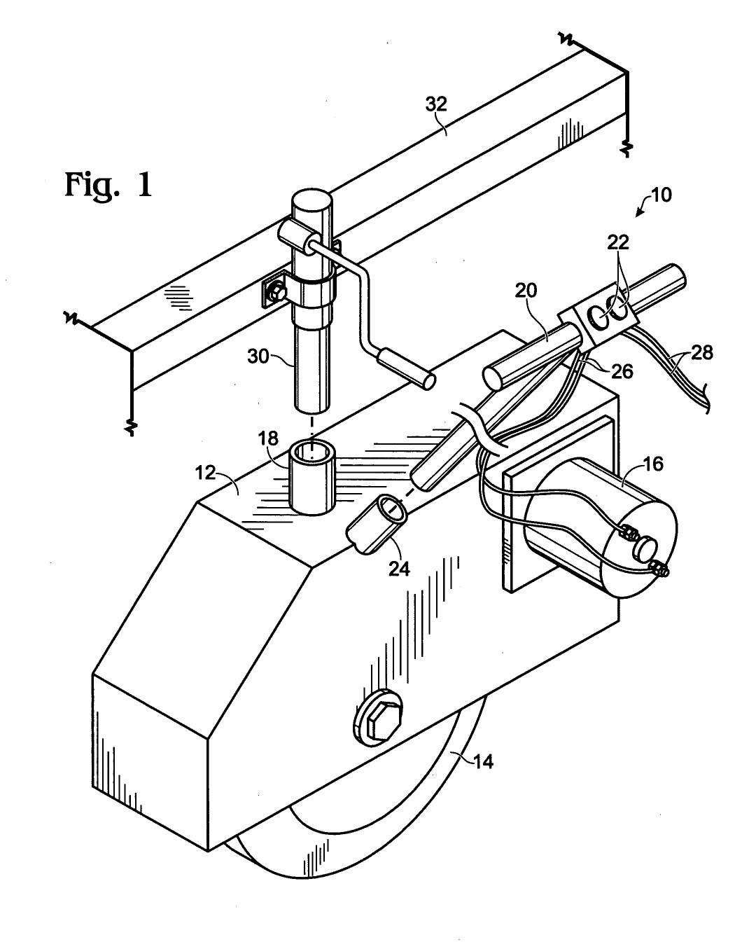

FIG. 1 is a perspective view of a powered dolly showing a handle separated from the main housing, a trailer tongue and trailer tongue jack.

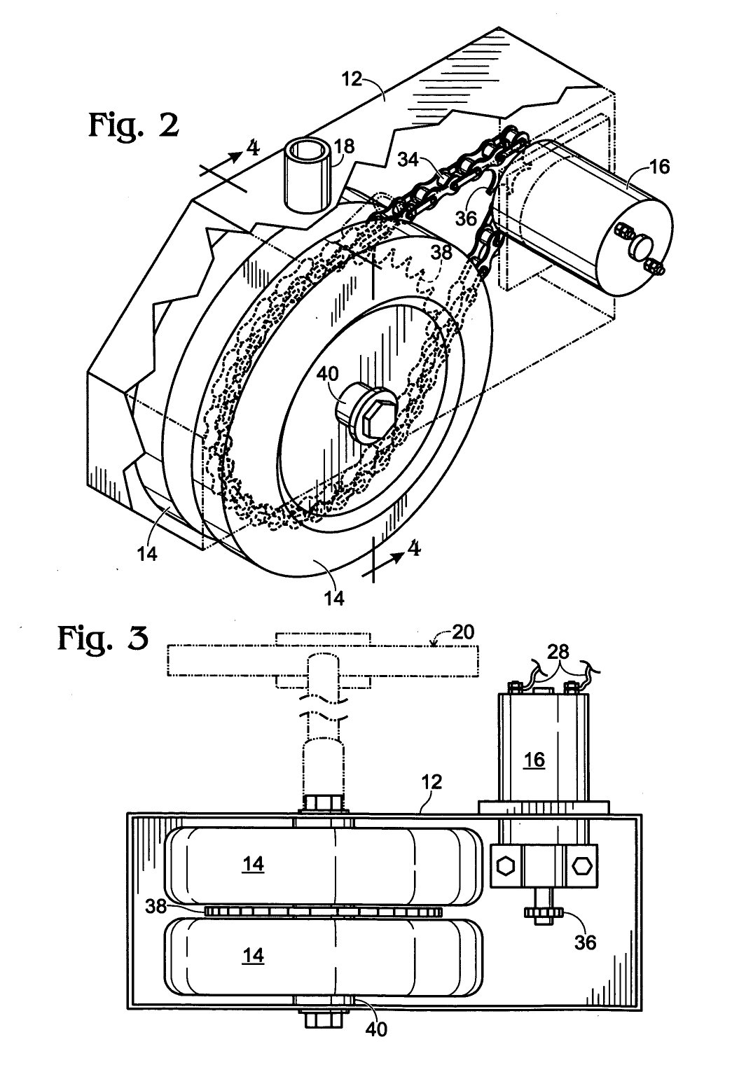

FIG. 2 is a cutaway perspective view of the powered dolly of FIG. 1 showing the wheels, motor, drive chain, body and handle.

FIG. 3 is a perspective view of the bottom of the dolly of FIG. 1 showing the body, wheel, axle and drive sprocket.

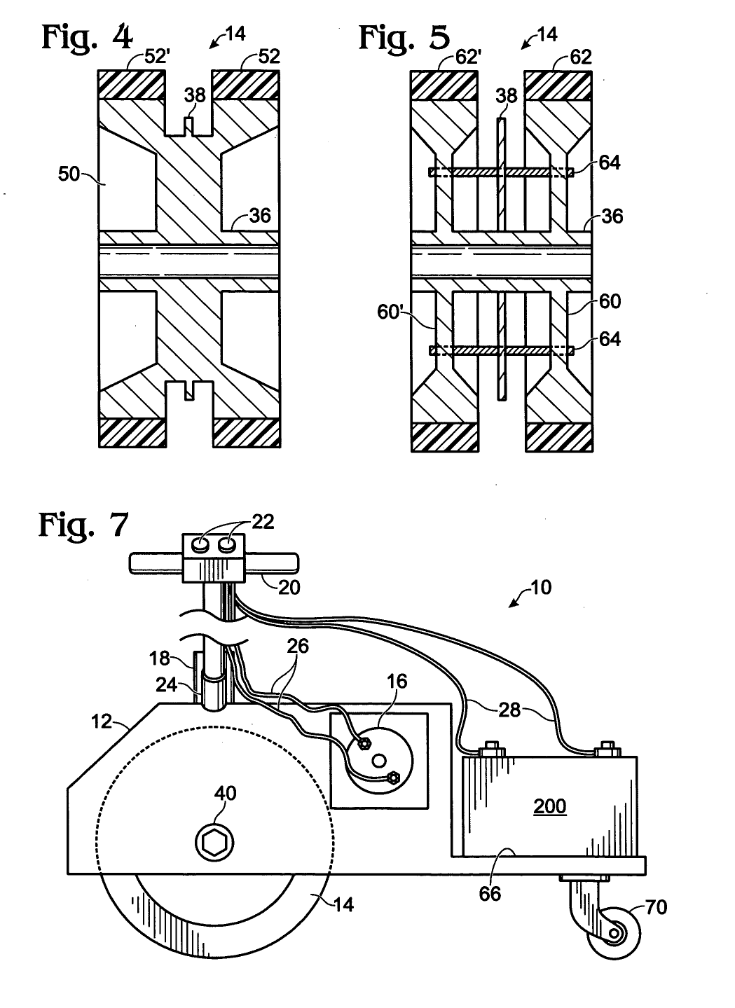

FIG. 4 is a cross section view of a wheel assembly showing the wheel body, the treads and wheel gear.

FIG. 5 is a cross section view of a wheel assembly showing the wheel bodies, the treads and wheel gear.

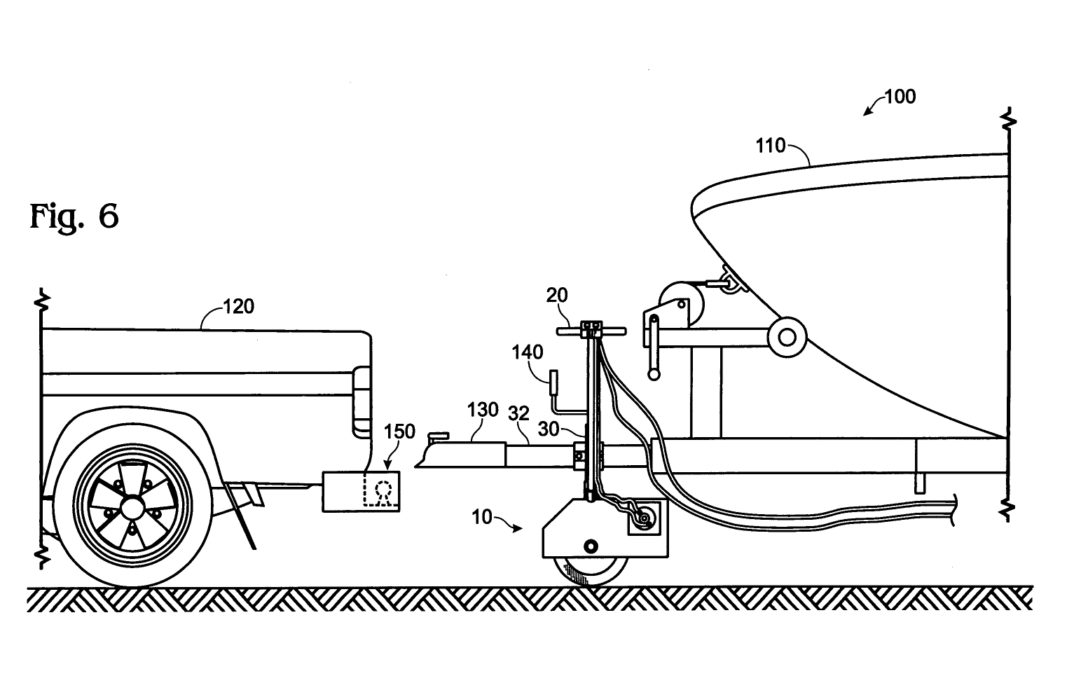

FIG. 6 is a perspective view of a powered dolly shown pulling a boat to attach to a vehicle with the user steering the dolly and trailer with a handle.

FIG. 7 is a perspective view of an alternate configuration of a powered dolly showing the body, wheels, motor and a power source.

### DETAILED DESCRIPTION

Referring to FIG. 1, a tug or powered dolly 10 is shown. Powered dolly 10 may include a body 12, wheel assembly 14, drive motor 16, support receptacle 18, steering handle 20, motor controls 22, handle receptacle 24, control cables 26 and power cables 28. Dolly 10 receives a vertical support member such as a trailer jack 30 at support receptacle 18 and retains tongue jack 30 during movement. Tongue jack 30 is connected to tongue 36. Handle 20 is used for steering and stabilizing dolly 10. Handle 20 supports motor control 22 and handle 20 is received by handle receptacle 24. Control cable 26 connects motor control 22 to motor 16. Power cable 28 runs from motor 16 to a power supply not shown.

FIG. 2 is a cutaway view of powered dolly 10 of FIG. 1. Similar numbering to the previous figure is used here and in subsequent figures for clarity. Shown again are body 12, wheel assembly 14, drive motor 16, steering handle 20, motor controls 22 and power cables 28. Also shown are drive chain 34, drive sprocket 36, wheel gear 38 (included in wheel assembly 14), and axle 40. Drive chain 34 transfers power from motor 16 and drive sprocket 36 to wheel gear 38. Wheel gear 38 is positioned between two wheels or tread faces and recessed from the largest circumference of the wheel in such a way as to not contact the pavement while in use.

Direction of travel of dolly 10 is perpendicular to axle 40 and support receptacle 18. Dolly 10 may move forward or backward.

Wheel assembly 14 is supported in body 12 by axle 40 attached to body 12. Support receptacle 18 is sized to receive tongue jack 30 or other vertical member connected to a tow load. Support receptacle 18 may be attached to body 12 above and perpendicular to wheel axle 40 so the vertical load is transferred to wheel axle 40 and the wheels with a minimum of twisting forces that would tend to make body 12 roll forward or back. The narrow width of wheel assembly 14 permits for a compact design and minimizes the forces required to steer dolly 10. The double wheels also increase the lateral stability, preventing dolly 10 from falling sideways.

Body 12 may substantially enclose wheel assembly 14. Body 12 may be an open frame.

Wheel assembly 14 may include a pair of wheels connected by axle 40 and separated by wheel gear 38. Axle 40 when assembled to wheel assembly 14 is located at the wheel axis. In an alternate configuration, wheel assembly 14 may be one wheel with two tread faces separated by wheel gear 38. Wheel assembly configurations are discussed further below.

Motor 16 may be any appropriately sized motor with speed adequate to the gear reduction. Motor 16 may be 12 volt, 120 volt or 240 volt. Motor 16 may be a gasoline or diesel motor, hydraulic, pneumatic or other drive source. Motor 16 may include geared speed reduction.

In a preferred mode, motor 16 is a 12 volt motor compatible with a vehicle battery with a power of 1.5 horsepower and a gear reduction of 153:1. The drive sprocket/gear wheel configuration may provide a further 6:1 gear reduction. In the preferred mode, wheel diameter is 10 inches, gear diameter is 7 inches and sprocket gear diameter is 1.25 inches.

As dolly 10 starts pulling to move the load, the wheels apply a horizontal force at axle 40 to body 12 while the load is still at rest. This results in a rotational or torque force between body 12 and support receptacle 18. Support receptacle 18 and body 12 may be sized to absorb the torque forces which are maximized at startup and diminish as the load begins moving. Preferably, the vertical distance between the tongue 32 and body 12 are minimized to reduce the torque forces.

Motor controls 22 located on handle 20 may include controls for forward motion, reverse motion, and stopping. Motor controls 22 may also include speed control. Motor controls 22 are operably connected to motor 16. Control 22 on handle 20 makes access to the controls more convenient during towing and maneuvering, but controls can be located anywhere including body 12 or on a separable remote control unit.

Handle 20 may be configured for steering of dolly 10. Handle 20 may be removable from body 12 for storage. Handle receptacle 24 may extend from body 12 in the plane perpendicular to the direction of travel. This orientation allows the user to stand as far as possible from the path of dolly 10 and the load, minimizing the risk of being run over by the dolly or load.

FIG. 3 is a bottom view of dolly 10 with drive chain 34 removed. Shown again are body 12, wheel assembly 14, drive motor 16, power cables 28, drive sprocket 36, wheel gear 38 and axle 40. Wheel assembly 14 is attached to body 12 with appropriate spacers, washers and thrust bearings (not shown) to allow unrestricted rotational movement of the wheels with minimal transverse movement along axle 40. Motor 16 may also be mounted to body 12. The motor mount may provide a range of positions for motor 16 to adjust tension to drive chain 34.

The functionality of wheel gear 38, drive chain 34 and sprocket 36 may be implemented by different components and still be within the scope of this disclosure. Wheel gear 38 may be driven by a shaft and worm gear from motor 16 rather than a drive chain. The components may be pulleys and a belt.

Wheel gear 38 is fixed in common rotation with at least one of the pair of wheels to transfer torque and motion to the wheel. The second wheel may rotate independently to allow ease of turning and maneuvering of dolly 10 while in motion or idling. Alternatively, both wheels may be fixed in common rotation to wheel gear 38 providing torque to both wheels.

The circumference of wheel gear 38 may be smaller than the outside circumference of wheel assembly 14. This configuration limits contamination by ground debris and wear that would occur with ground contact. Wheel assembly 14 with a wheel gear size approaching the wheel size also provides the largest gear reduction practicable.

FIG. 4 is a cross section through the center of wheel assembly 14 showing one possible configuration of wheel assembly 14 and wheel gear 38. Wheel assembly 14 has a single wheel body 50 which mounts treads 52 and 52′ on the outer circumferences. Wheel gear 38 is attached to wheel body 50 on an inner circumference between treads 52 and 52′.

FIG. 5 is a cross section through the center of an alternative configuration of wheel assembly 14. Wheel assembly 14 includes a first wheel body 60 and a second wheel body 60′. Wheel body 60 mounts tread 62 on its circumference. Wheel body 60′ mounts tread 62′ along its circumference. Wheel gear 38 is disposed between wheel body 60 and wheel body 60′. Wheel bodies 60 and 60′ and wheel gear 38 are commonly mounted on axle shaft 40. Axle 40 is located at the wheel axis.

Wheel bodies 60 and 60′ and wheel gear 38 may also be joined by one or more connectors 64 to maintain common rotation of the parts. Alternatively, connectors 64 may only be common to wheel gear 38 and one wheel body 60. This may allow free rotation of one wheel while the other wheel is driven. One free wheel in this configuration may provide ease of steering dolly 10 since only one wheel must pivot on the pavement during dolly rotation rather than two wheels. One free wheel also reduces torque stresses on wheel assembly 14 during maneuvering.

Alternately, axle 40 may be a keyed shaft. A gear or wheel key mounted to a keyed shaft will rotate only with the shaft. Gear 38 and at least one wheel body may be attached to the keyed shaft in order to maintain common rotation orientation and to transfer torque to the wheel. When the wheel and gear maintain a common rotation orientation they are fixed in rotation.

Traction faces may be any material that prevents slipping of the wheel assembly against the road surface. Traction faces on the wheel bodies can be pneumatic, hydraulic or solid tires.

FIG. 6 is a perspective view 100 of dolly 10 in use. A trailered load 110 is being moved to a position proximate a vehicle 120 using dolly 10. Trailer 110 includes tongue 32 and tongue jack 30. Trailer tongue 32 is configured to connect to a ball 150 on vehicle 120. Dolly 10 is steered by the operator using handle 20. Steering with handle 20 rotates dolly 10 about the axis of tongue jack 30, redirects the pulling force and direction of travel of dolly 10, causing trailer 110 to turn.

Referring to FIG. 7, an alternate configuration of dolly 10 is shown including a power supply 200. Power supply 200 may be a generator, a lead acid battery, another battery using a different chemistry or any source which provides an appropriate motive force to motor 16. Source 200 and motor 16 could be a hydraulic pump and hydraulic drive or a compressor and air drive. This configuration, with power source 200 proximate to dolly 10, removes the need for cables connected to a separate, fixed power source allowing dolly 10 to be used in remote locations. Additional pivoting wheels or castors may be provided for support, mobility and stability.

While specific examples have been presented, these are examples only. The configuration can be varied and components can be rearranged and still fall within the scope of this disclosure.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

I claim:

1. A tow dolly for towing a wheeled load comprising:
proximate coaxial wheels separated by a coaxial gear;
a motor operably connected to the gear; and
a housing configured to mount and substantially enclose the motor and wheels;
wherein
the gear is fixed in rotation to at least one wheel; and
the housing receives a portion of the load and transfers the load to the wheels.

2. The tow dolly of claim 1 where the motor is operably connected to the gear by a linked chain.

3. The tow dolly of claim 1 further comprising a steering bar extending from the housing perpendicular to the direction of travel.

4. The tow dolly of claim 3 where the steering bar includes control inputs to control the motor.

5. The tow dolly of claim 1 where the motor is a direct current motor.

6. The tow dolly of claim 1 further comprising at least one wheel with an axis distinct from the coaxial wheels.

7. The tow dolly of claim 1 further comprising a power source for the motor.

8. A trailer tow comprising:
a wheel assembly including:
two tread faces;
a gear between the two tread faces to drive the wheel assembly; and
a wheel body supporting the gear and two tread faces;
a receptacle configured to receive a substantially vertical trailer component; and
a motor that drives the gear.

9. The trailer tow of claim 8 where the tread faces are pneumatic or solid tires.

10. The trailer tow of claim 8 where the trailer component is a tongue jack and the receptacle is substantially coplanar and perpendicular to the wheel axis.

11. The trailer tow of claim 8 further comprising a steering bar, including motor controls, substantially coplanar with the receptacle and wheel axis.

12. The trailer tow of claim 8 where the motor is a direct current motor.

13. The trailer tow of claim 8 where the gear is fixed to at least one of the tread faces.

14. A method for moving a wheeled load with a tug comprising the steps of:
receiving a vertical member of a wheeled load;
driving two proximate, coaxial wheels separated by a gear substantially vertically aligned with the received vertical member; and
steering the tug with a handle extending substantially perpendicular to the direction of motion.

15. The moving method of claim 14 where the wheels are driven by a direct current motor.

16. The moving method of claim 14 where the handle includes motor controls.
